(19) United States
(12) Patent Application Publication
(10) Pub. No.: US 2024/0265716 A1
(43) Pub. Date: Aug. 8, 2024

(54) IMAGE PROCESSING APPARATUS AND LABEL PRINTING SYSTEM

(71) Applicant: Toshiba Tec Kabushiki Kaisha, Tokyo (JP)

(72) Inventor: Hiroyuki KATO, Mishima Shizuoka (JP)

(21) Appl. No.: 18/420,451

(22) Filed: Jan. 23, 2024

(30) Foreign Application Priority Data
Feb. 2, 2023 (JP) 2023-014628

(51) Int. Cl. G06V 30/14; B65H 16/00; G06V 30/224; G06V 30/26

(52) U.S. Cl. CPC G06V 30/1444; B65H 16/005; G06V 30/2247; G06V 30/26; B65H 2511/414; B65H 2553/43; B65H 2557/11; B65H 2801/39; B65H 2801/75

(57) ABSTRACT

According to an embodiment, an image processing apparatus has a first interface for communicating with a server, a second interface for communicating with a label printer, and a third interface for acquiring an image including a label image. A processor of the apparatus is configured to receive the image via the third interface, extract the label image from the received image, perform image processing on the extracted label image, transmit the processed extracted label image to the server via the first interface along with a request to generate label data based on processed extracted label image, receive the generated label data from the server via the first interface, and transmit the received label data to the label printer along with a request to print a label corresponding to the label data.

### CROSS-REFERENCE TO RELATED APPLICATION

This application is based upon and claims the benefit of priority from Japanese Patent Application No. 2023-014628, filed Feb. 2, 2023, the entire contents of which are incorporated herein by reference.

### FIELD

Embodiments relate to an image processing apparatus and a label printing system

### BACKGROUND

In the related art, labels to be attached to merchandise or the like can be prepared by using a dedicated application program (label editing tool) operating on a computer (PC) or the like. For example, a user arranges lines, characters, text, or the like by using a label editing tool on a PC and designs a label having a designated printing area for a bar code.

The PC converts the label designed by a user using the label editing tool into data (label data) for printing and then supplies the label data to a bar code printer. Accordingly, the bar code printer can print a label created by the user. However, each new label needs to be designed by using the label editing tool. For this reason, printing a new label with a bar code printer has a problem in that it takes a lot of time and effort for the user.

### BRIEF DESCRIPTION OF THE DRAWINGS

FIG. 1 is a diagram illustrating a label printing system including a digital multifunction peripheral.

FIG. 2 is a perspective diagram of a digital multifunction peripheral including an image processing apparatus.

FIG. 3 is a block diagram of a control system in a digital multifunction peripheral.

FIG. 4 is a block diagram of a bar code printer in a label printing system.

FIG. 5 is a block diagram of a server in a label printing system.

FIG. 6 is a diagram illustrating an example of a format of a label created by a label printing system.

FIG. 7 is a diagram illustrating an example of label data of a label created by a label printing system.

FIG. 8 is a diagram illustrating an example of a label created by a label printing system.

FIG. 9 is a diagram illustrating an example of label data of a label created by a label printing system.

FIG. 10 is a diagram illustrating an example in which printed labels are arranged on a document platen of a digital multifunction peripheral.

FIG. 11 is a diagram illustrating an example of label images cut out from a scanned image by a digital multifunction peripheral.

FIG. 12 is a diagram illustrating an example of label images acquired from a digital multifunction peripheral by a server of a label printing system.

FIG. 13 is a diagram illustrating an example of label data generated by a server of a label printing system based on label images.

FIG. 14 is a sequence diagram illustrating an operation example of a label printing system.

FIG. 15 is a flowchart illustrating an operation example of a digital multifunction peripheral.

### DETAILED DESCRIPTION

Embodiments provide an image processing apparatus and a label printing system capable of easily acquiring label data for additional label creation or the like.

In general, according to one embodiment, an image processing apparatus includes a first interface for communicating with a server, a second interface for communicating with a label printer, a third interface for acquiring an image including a label image, and a processor. The processor is configured to receive the image via the third interface, extract the label image from the received image, perform image processing on the extracted label image, transmit the processed extracted label image to the server via the first interface along with a request to generate label data based on processed extracted label image, receive the generated label data from the server via the first interface, and transmit the received label data to the label printer along with a request to print a label corresponding to the label data.

Certain example embodiments will be described with reference to the drawings.

First, a configuration of a label printing system 1 including a digital multifunction peripheral 2 (MFP, multi-functional peripheral) including an image processing apparatus therein according to an embodiment will be described.

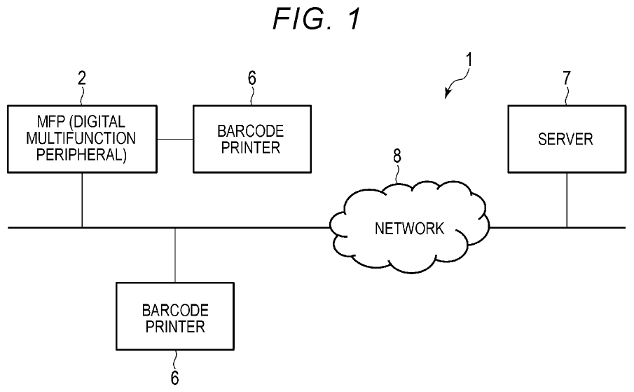

FIG. 1 is a block diagram illustrating schematically a configuration example of the label printing system 1 including the digital multifunction peripheral (MFP) 2 according to an embodiment.

As illustrated in FIG. 1, the label printing system 1 has a digital multifunction peripheral 2, a bar code printer 6 (also referred to as a printer 6), and a server 7. The digital multifunction peripheral 2 is serially connected to the bar code printer 6. In some examples, the digital multifunction peripheral 2 may be connected to the bar code printer 6 via a local area network. The digital multifunction peripheral 2 communicates with the server 7 through a network 8.

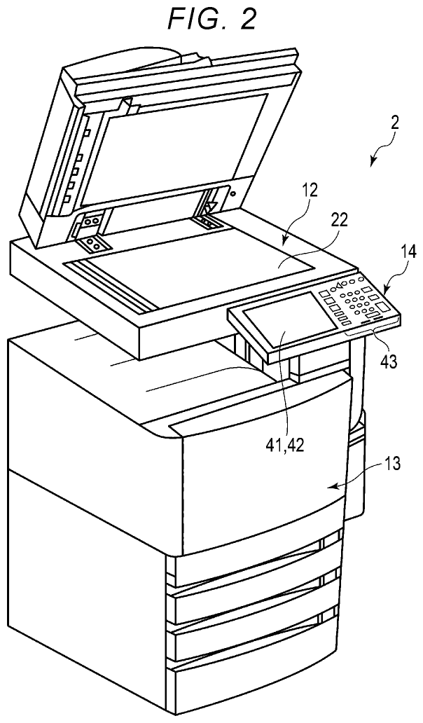

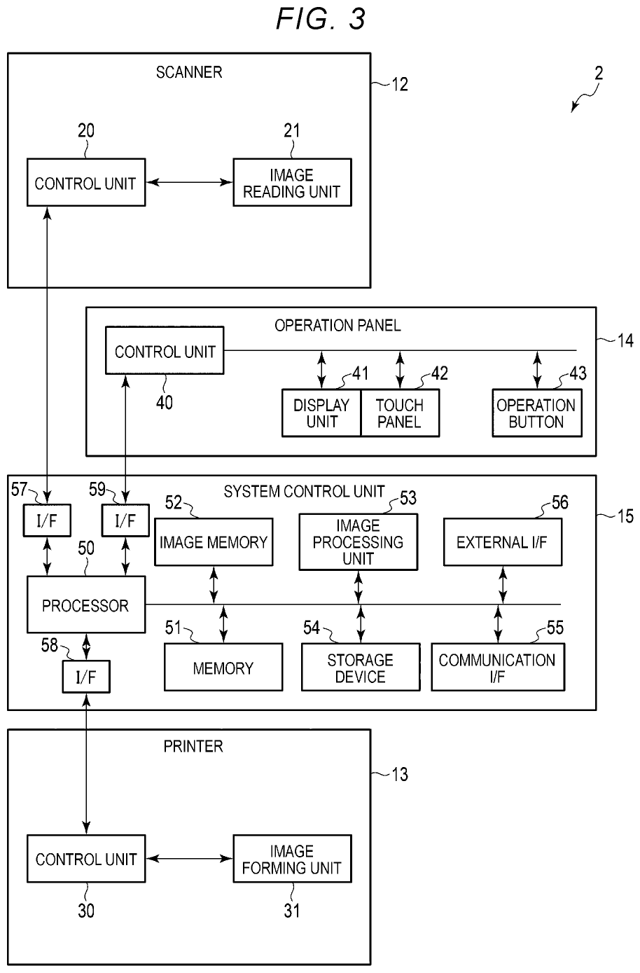

The digital multifunction peripheral 2 has a scanner 12 (refer to FIG. 2) for reading (acquiring) an image. The digital multifunction peripheral 2 acquires the image (scanned image) read by the scanner 12. In addition, the digital multifunction peripheral 2 has a system control unit 15 (refer to FIG. 3) including an image processing unit 53 or the like. The digital multifunction peripheral 2 executes image processing on the scanned image using the system control unit 15.

In this embodiment, the digital multifunction peripheral 2 reads a label (or labels) using the scanner and extracts an image of the label(s) from the overall scanned image. The digital multifunction peripheral 2 transmits the extracted image of the label to the server 7. The digital multifunction peripheral 2 acquires the label data, which is print data for printing a label, from the server 7. The label data can be generated by the server 7 from the extracted image of the label. The digital multifunction peripheral 2 supplies the label data (acquired from the server 7) to the bar code printer 6.

The bar code printer 6 prints a label image on a medium to be used as a label (e.g., label stock or the like). In the configuration example illustrated in FIG. 1, the bar code printer 6 communicates with the digital multifunction peripheral 2. In the example, the bar code printer 6 acquires the label data from the digital multifunction peripheral 2. The bar code printer 6 acquires text information to be printed on individual labels, a symbol image, and information necessary for the individual labels such as bar codes. The bar code printer 6 in this example adds the information necessary for the individual labels to the label data and prints the appropriate label image on the medium.

The server 7 communicates with the digital multifunction peripheral 2. The server 7 acquires a label image (scanned label image) from the digital multifunction peripheral 2. The server 7 analyzes a format or the like of the label in the label image. The server 7 generates label data containing information indicating the format of the label based on the analysis of the label image. The server 7 transmits the label data generated from label images to the digital multifunction peripheral 2.

The digital multifunction peripheral 2 is an example of an image processing apparatus according to an embodiment. In some examples, the digital multifunction peripheral 2 may include or provide some or all of the functions of the server 7. For example, the label printing system 1 may be configured with a digital multifunction peripheral 2 integrated, into a unitary apparatus or the like, the server 7 and the bar code printer 6. In addition, the digital multifunction peripheral 2 may include a portion or all of the functions of the bar code printer 6. For example, the label printing system 1 may be configured with a digital multifunction peripheral 2 integrated with the bar code printer 6. In addition, the label printing system 1 may be configured as a single digital multifunction peripheral 2 or a plurality of digital multifunction peripherals 2 with a server 7 and bar code printers 6.

Next, the configuration of the digital multifunction peripheral 2 according to an embodiment will be described. FIG. 2 is a perspective diagram illustrating an appearance of the digital multifunction peripheral 2 according to the embodiment.

As illustrated in FIG. 2, the digital multifunction peripheral 2 has a scanner 12, a printer 13, and an operation panel 14.

The scanner 12 is installed on the upper portion of a main body of the digital multifunction peripheral 2. The scanner 12 is an image reader (image input device) for optically reading (scanning) an image of a document. The scanner 12 has a document platen 22 formed of a transparent material, such as glass, on which the document can be placed. The scanner 12 provides an image of the document on the document platen 22. The scanner 12 reads an image of a document on the document platen 22 using an image reading unit 21. In other examples, the scanner 12 may be a camera or the like and is not particularly limited so long as the scanner 12 can acquire an image of a document (e.g., a label).

The printer 13 prints an image on a paper sheet or the like. The printer 13 has an image forming unit 31 for forming an image on the paper sheet supplied from a paper feed cassette. The image forming unit 31 may use any image forming method. For example, in the case of an electrophotographic system, the image forming unit 31 forms a developer image on a photoreceptor drum or the like and transfers the developer image to the paper sheet. In the case of an inkjet system, the image forming unit 31 forms an image on a paper sheet by ink ejected from an inkjet head.

The operation panel 14 is a user interface. The operation panel 14 has a display unit 41 (also referred to as a display 41), a touch panel 42, and a plurality of operation buttons 43. The display unit 41 displays an operation guide (operation guidance) or the like. The touch panel 42 is provided on a display screen of the display unit 41. The touch panel 42 detects a position on the display screen of the display unit 41 touched by the user.

Next, the configuration of the control system in the digital multifunction peripheral 2 according to an embodiment will be described.

FIG. 3 is a block diagram illustrating a control system in the digital multifunction peripheral 2 according to an embodiment.

The digital multifunction peripheral 2 has a scanner 12, a printer 13, an operation panel 14, and a system control unit 15. The system control unit 15 is connected to the scanner 12, the printer 13, and the operation panel 14.

In FIG. 3, the system control unit 15 has a processor 50, a memory 51, an image memory 52, an image processing unit 53, a storage device 54, a communication interface (I/F) 55, an external interface (I/F) 56, and interfaces (I/F) 57, 58, and 59.

The processor 50 executes control of each unit, information processing, and the like. The processor 50 is, for example, a CPU. The processor 50 executes a program stored in the memory 51 or the storage device 54. The processor 50 outputs an operation instruction to each storage device or processes various pieces of information from each storage device by executing a program (software). The processor 50 is connected to the scanner 12, the printer 13, and the operation panel 14 through the interfaces 57, 58, and 59.

The memory 51 includes a memory such as a random access memory (RAM), a read-only memory (ROM), and an NVM (non-volatile memory). The RAM functions as a working memory or a buffer memory. The ROM is a non-volatile memory that cannot be rewritten. The ROM functions as a program memory. The NVM is a rewritable nonvolatile memory. The NVM stores a program, control data, and data such as setting information.

The image memory 52 stores the image data. For example, the image memory 52 functions as a page memory for expanding the image data used as a processing object. The storage device 54 stores the data such as a program, control data, and setting information. The storage device 54 is a rewritable nonvolatile memory. For example, the storage device 54 is a hard disk drive (HDD) or a solid-state drive (SSD).

The communication I/F 55 is an interface for performing data communication with an external apparatus. For example, the communication I/F 55 is a network interface communicating with an external apparatus such as the server 7 via the network 8.

The external I/F 56 is an interface for connecting to an external apparatus. For example, the external I/F 56 is connected to the bar code printer 6. The external I/F 56 may be connected to an external apparatus by wire or may be connected to an external apparatus wirelessly.

The I/F 57 is an interface for connecting to the scanner 12 or the like. For example, the processor 50 acquires the data of the image read by the scanner 12 through the I/F 57. In general, the I/F 57 is an interface for acquiring a scanned image including therein an image of the printed label. However, the I/F 57 may acquire an input image including the label image as prepared or acquired by various means. For example, the I/F 57 may acquire an image of a label from a camera rather than scanner 12.

The I/F 58 is an interface for connecting to the printer 13. The I/F 59 is an interface connecting to the operation panel 14. For example, the processor 50 supplies the data to be displayed on the display unit 41 via the I/F 59 to the operation panel 14. In addition, the processor 50 acquires the data input via the touch panel 42 or the operation button 43 on the operation panel 14 via the I/F 59.

As illustrated in FIG. 3, the scanner 12 has a control unit 20 (scanner control unit) and an image reading unit 21 (image reading mechanism).

The control unit 20 can include a processor such as a CPU, various types of the memories and the interfaces. The control unit 20 controls the operation of the scanner 12 by executing a program stored in the memory of the scanner 12 or the like. The control unit 20 is connected to the processor 50 through the I/F 57 in the system control unit 15. For example, the control unit 20 controls the operation of the scanner 12 in response to an instruction from the system control unit 15. In addition, the control unit 20 supplies data of the images read by the image reading unit 21 to the system control unit 15.

The image reading unit 21 reads (e.g., scans) the document on the document platen 22. The image reading unit 21 has, for example, an illumination source (light source), an optical system, a photoelectric conversion unit, and the like. The illumination source irradiates the document platen 22 with light. The optical system guides reflected light from a document on the document platen 22 to the photoelectric conversion unit. The photoelectric conversion unit converts light from the document into an electric signal. For example, the image reading unit 21 reads the image of a label placed on the document platen 22 and acquires a scanned image including the image of the label.

As illustrated in FIG. 3, the printer 13 has a control unit 30 (printer control unit) and an image forming unit 31.

The control unit 30 can include a processor, such as a CPU, along with various types of memories and interfaces. The control unit 30 controls the operation of the printer 13 by executing the program stored in the memory of the printer 13 or the like. The control unit 30 is connected to the processor 50 via the I/F 58 in the system control unit 15. For example, the control unit 30 executes print processing for the image forming unit 31 in response to an operation instruction from the system control unit 15.

The image forming unit 31 forms the image on a medium such as paper. The image forming unit 31 is not limited to any specific image forming method. For example, the image forming unit 31 may be an electrophotographic image forming mechanism. The electrophotographic image forming unit 31 includes a conveyance system, an exposure device, a photoreceptor drum, a developing device, an intermediate transfer body, a transfer unit, and a fixing device. In some examples, the image forming unit 31 malfunction as a bar code printer 6 for printing labels based on the label data.

As illustrated in FIG. 3, the operation panel 14 has a control unit 40 (panel control unit), a display unit 41, a touch panel 42, and an operation button(s) 43.

The control unit 40 can include a processor such as a CPU, various types of the memories and the interfaces. The control unit 40 controls the operation of the operation panel 14 by executing a program stored in the memory. The control unit 40 is connected to the processor 50 through the I/F 59 in the system control unit 15. For example, the control unit 40 displays an image on the display unit 41 in response to an instruction from the system control unit 15. In addition, the control unit 40 notifies the system control unit 15 of user inputs to the touch panel 42 or the operation buttons 43.

The display unit 41 controls display contents in response to an operation instruction from the control unit 40. The touch panel 42 is provided on a display screen of the display unit 41 and detects a touched position on the display screen. For example, the control unit 40 displays an icon selectable on the touch panel 42 together with operation guidance on the display screen of the display unit 41. The control unit 40 determinates information input by the user according to the touched position detected by the touch panel 42. An operation button 43 can be hard keys such as a start key and a reset key.

Next, the configuration of a bar code printer 6 in the label printing system 1 according to the embodiment will be described.

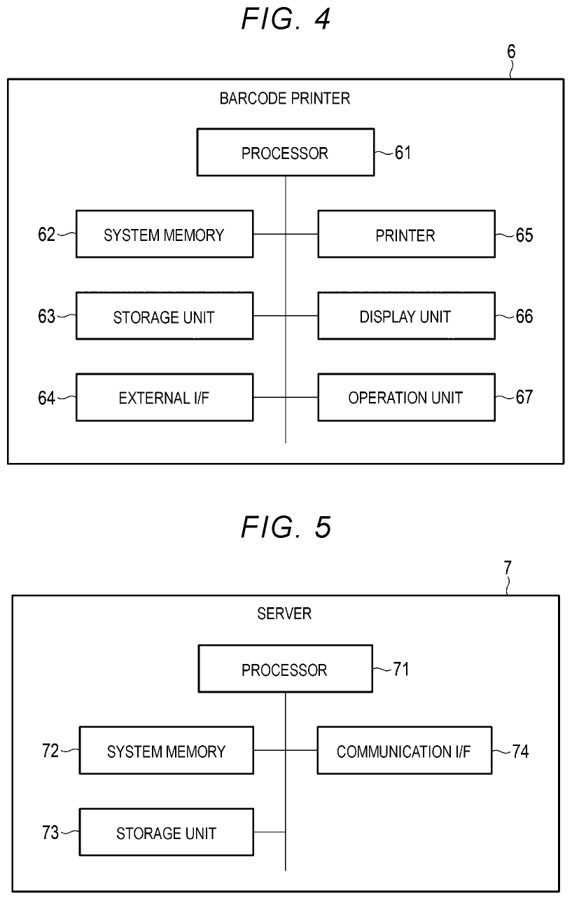

FIG. 4 is a block diagram of the control system in a bar code printer 6 of the label printing system 1 according to an embodiment.

The bar code printer 6 has a processor 61, a system memory 62, a storage unit 63, an external interface (I/F) 64, a printer 65, a display unit 66, and an operation unit 67.

The processor 61 executes control of each unit, information processing, and the like. The processor 61, for example, is a CPU. The processor 61 executes a program stored in the system memory 62 or the storage unit 63. The processor 61 outputs an operation instruction to each unit and processes various pieces of information from each unit by executing the program.

The system memory 62 includes a memory such as a random access memory (RAM), a read-only memory (ROM), and an NVM. The RAM functions as a working memory or a buffer memory. The ROM is a non-volatile memory that cannot be rewritten. The ROM functions as a program memory. The NVM is a rewritable nonvolatile memory. The NVM stores a program, control data, and data such as setting information.

The storage unit 63 is a rewritable nonvolatile memory. For example, the storage device 54 is a hard disk drive (HDD) or a solid-state drive (SSD). The storage unit 63 stores, for example, the image data or the like. In addition, the storage unit 63 may store the data such as a program, control data, and setting information.

The external I/F 64 is for connecting to an external apparatus. The external I/F 66 may be connected to an external apparatus by wire or may be connected to an external apparatus wirelessly. According to the configuration example illustrated in FIG. 1, the external I/F 64 is connected to the digital multifunction peripheral 2.

The printer 65 prints an image of a label on label stock or the like. The printer 65 prints on a medium having a predetermined width (label width). The printer 65 can be preset or designed with a fixed printable label width. Information indicating the size of the printable label width for the printer 65 can be notified (transmitted) to the digital multifunction peripheral 2.

The display unit 66 includes a display device such as a liquid crystal display device. The display unit 66 controls display contents according to an operation instruction from the processor 61. The operation unit 67 can comprise a touch panel and/or an operation button, and the like. For example, the display unit 66 and the operation unit 67 can comprise a display device attached to a touch panel. For example, the processor 61 displays an icon selectable on the touch panel as the operation unit 67 on the display screen of the display unit 41 together with operation guidance. Accordingly, the processor 61 acquires the input data corresponding to the touched position detected by the touch panel.

Next, the configuration of a server 7 in a label printing system 1 according to an embodiment will be described.

FIG. 5 is a block diagram illustrating the configuration example of the control system in the server 7 of the label printing system 1 according to an embodiment.

The server 7 has a processor 71, a system memory 72, a storage unit 73, and a communication interface (I/F) 74.

The processor 71 executes control of each unit, information processing, and the like. The processor 71 is, for example, a CPU. The processor 71 executes a program stored in the system memory 72 or the storage unit 73. The processor 71 outputs an operation instruction to each unit and processes various pieces of information from each unit by executing a program.

The system memory 72 includes a memory such as a random access memory (RAM), a read-only memory (ROM), and an NVM. The RAM functions as a working memory or a buffer memory. The ROM is a non-volatile memory that cannot be rewritten. The ROM functions as a program memory. The NVM is a rewritable nonvolatile memory. The NVM stores a program, control data, and data such as setting information.

The storage unit 73 is a rewritable nonvolatile memory. For example, the storage unit 73 is a hard disk drive (HDD) or a solid-state drive (SSD). The storage unit 73 stores, for example, the image data or the like. In addition, the storage unit 73 may store the data such as a program, control data and setting information. For example, the storage unit 73 stores a program to generate the label data for printing labels from analysis of the acquired (e.g., scanned) image of the label.

The communication I/F 74 is a communication interface to communicate with an external apparatus. The communication I/F 74 can be a network interface to communicate with an external apparatus via the network 8. The communication I/F 74 may include an interface to communicate with an external apparatus by wire, or may include an interface to communicate with an external apparatus wirelessly. According to the configuration example illustrated in FIG. 1, the communication I/F 74 can include an interface to communicate with the digital multifunction peripheral 2.

Next, the label data for the bar code printer 6 to print labels in the label printing system 1 according to an embodiment will be described.

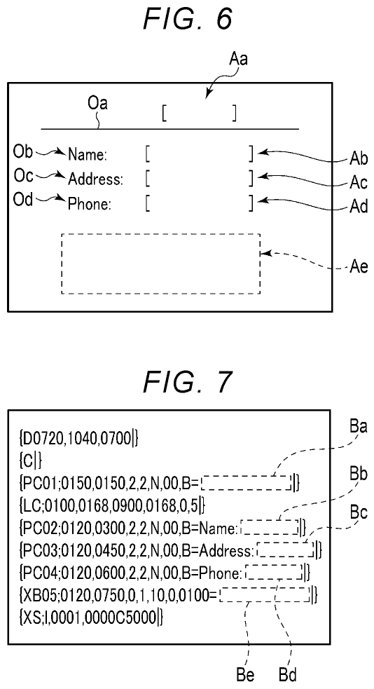

FIG. 6 is a diagram illustrating an example of the label format of a label with the image areas for a plurality of pieces of variable data. FIG. 7 is a diagram illustrating an example of label data to be printed on the labels with the label format illustrated in FIG. 6.

The label illustrated in FIG. 6 has a format with image areas Aa, Ab, Ac, Ad, and Ae, a partition line Oa, and texts Ob, Oc, and Od are arranged. Each of the image areas Aa, Ab, Ac, Ad, and Ae is an area where variable data is to be printed. The partition line Oa is a straight line extending in the horizontal direction for vertically dividing the image area of the label. The image area Aa of the variable data is arranged above the partition line Oa in this label format.

The texts Ob, Oc, and Od are “Name”, “Address”, and “Phone” in this format. The texts Ob, Oc, and Od are arranged below the partition line Oa. The image areas Ab, Ac, and Ad for the variable data are arranged at positions corresponding to the texts Ob, Oc, and Od, respectively. The image area Ae for the variable data is arranged below the image areas Ab, Ac, and Ad and the texts Ob, Oc, and Od.

As illustrated in FIG. 7, the label data defines the arrangement (format) for the image areas Aa, Ab, Ac, Ad, and Ae, the partition line Oa, and the texts Ob, Oc, and Od. In addition, the label data has data areas Ba, Bb, Bc, Bd, and Be for storing the variable data to be printed in the image areas Aa, Ab, Ac, Ad, and Ae. In the case of printing a label, the variable data to be printed on the image areas Aa, Ab, Ac, Ad, and Ae are set by inclusion in the data areas Ba, Bb, Bc, Bd, and Be.

In the example illustrated in FIG. 7, the label data also serves to define which the input device will input (supply) the variable data to be included in the data areas Ba, Bb, Bc, Bd, and Be. For example, the bar code printer 6 acquires a date value as the variable data to be set in the data area Ba. The operator may manually input the character string of a name (Name) as the variable data to be set in the data area Bb by using the operation unit 67 of the bar code printer 6. The operator may also input the character string of an address (Address) as the variable data to be set in the data area Bc by using the operation unit 67 of the bar code printer 6. The operator may also input the character string of a telephone number (Phone) as the variable data to be set in the data area Bd by using the operation unit 67 of the bar code printer 6. The bar code printer 6 may also acquire a bar code (bar code value) as the variable data to be set in the data area Be.

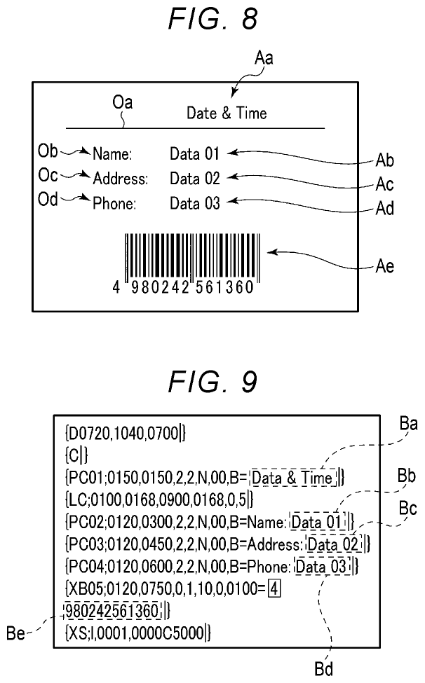

FIG. 8 is a diagram illustrating an example of a label in which variable data has been printed on the image areas of each variable data field. FIG. 9 is a diagram illustrating an example of the label data corresponding to the printed label illustrated in FIG. 8.

In the label illustrated in FIG. 8, a character string or a bar code as variable data is printed on the image areas Aa, Ab, Ac, Ad, and Ae. For example, a character (or number) string of “Date and Time” is printed on the image area Aa. “Data 01” is printed on the image area Ab, “Data 02” is printed on the image area Ac, and “Data 03” is printed on the image area Ad. The bar code is printed on the image area Ae. The printed values depicted in FIG. 8 are arbitrary and merely representative.

In the example illustrated in FIG. 9, the respective data (variable data) are set in the data areas Ba, Bb, Bc, Bd, and Be of the label data. The data areas Ba, Bb, Bc, and Bd store the data of the character string with characters or numbers which are variable data for each label. The data area Be stores the data indicating the bar code which is also variable data for each label.

The bar code printer 6 for executing printing of the label acquires the variable data to be set in the data areas Ba, Bb, Bc, Bd, and Be. After acquiring the variable data for each area, the bar code printer 6 generates the label data (print data) with the specific variable data embedded therein for a label to be printed.

For example, when printing the label, the bar code printer 6 automatically acquires the date and sets the data indicating the date in the data area Ba. The bar code printer 6 sets a character string indicating a name (Name) as input by the operator using the operation unit 67 to the data area Bb. The bar code printer 6 sets a character string indicating an address (Address) as input by the operator using the operation unit 67 to the data area Bc. The bar code printer 6 sets a character string indicating a telephone number (Phone) as input by the operator using the operation unit 67 to the data area Bd. The bar code printer 6 also acquires the bar code for the label and sets data corresponding to the bar code in the data area Be.

Next, the processing of a scanned image (input image) including an image of a label of the label printing system 1 according to an embodiment will be described.

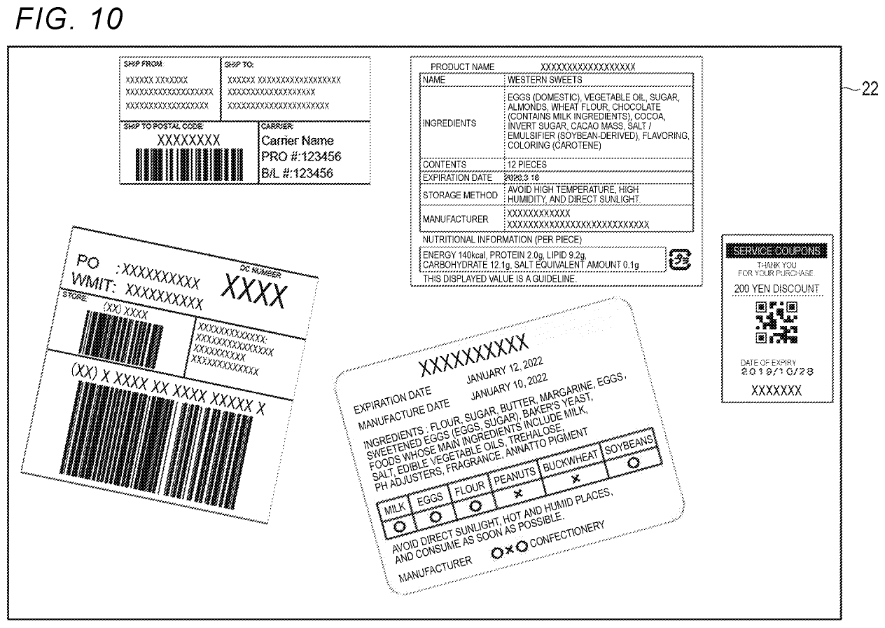

FIG. 10 is a diagram illustrating an example in which a plurality of printed labels is arranged on the document platen 22 of the digital multifunction peripheral 2. The digital multifunction peripheral 2 scans the printed labels using the scanner 12 to acquire the label data of at least one printed label. When acquiring the label data of a printed label, an operator places a printed label on the document platen 22 of the digital multifunction peripheral 2. If there are a plurality of printed labels, the operator arranges each label on the document platen 22 so that the labels do not overlap each other. However, the plurality of printed labels need not be arranged in the same direction and may be arranged on the document platen 22 arbitrarily or at random.

The digital multifunction peripheral 2 acquires the image including the printed label(s) arranged on the document platen 22 using the scanner 12 in response to scanning instruction of an operator. The system control unit 15 of the digital multifunction peripheral 2 acquires the scanned image (input image) including the printed label(s) as read by the scanner 12.

The system control unit 15 cuts out (extracts) images (label images) of the individual labels from the overall scanned image. Furthermore, the system control unit 15 performs image processing such as inclination correction on the label images cut out from the scanned image. For example, the system control unit 15 recognizes the top and bottom (upper and lower edges) of the individual extracted label images. The system control unit 15 corrects the inclination of the label image based on the recognition of the top and bottom of the individual label images.

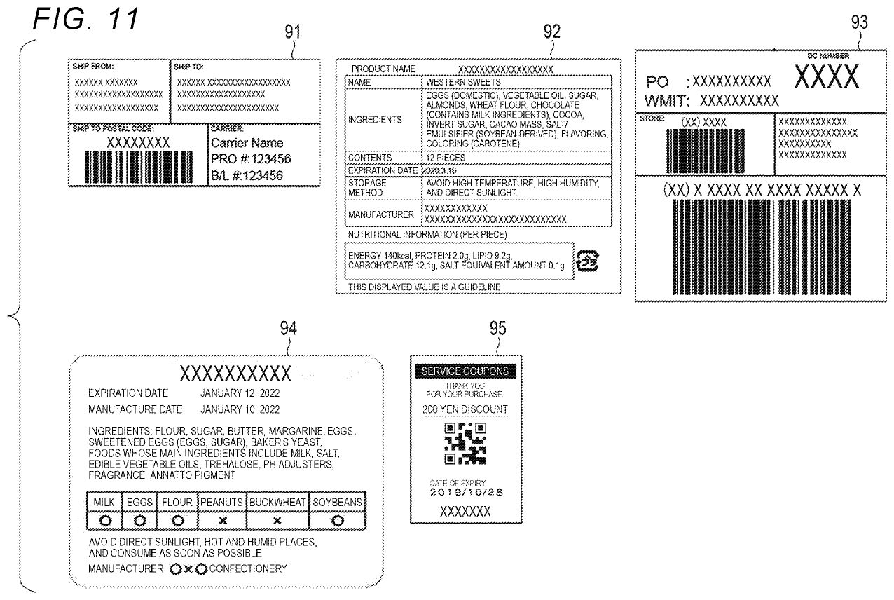

FIG. 11 is a diagram illustrating an example of a plurality of label images cut out from a scanned image by the digital multifunction peripheral 2.

The digital multifunction peripheral 2 acquires the scanned image including the label images using the scanner 12 after scanning has been instructed with the labels arranged on the document platen 22. In this case, the scanned image can include a label image arranged in any orientation. The system control unit 15 extracts the individual label images from the scanned image and performs image processing such as inclination correction to the cut-out individual label images.

For example, if the scanning is instructed with a plurality of labels arranged as illustrated in FIG. 10, the scanner 12 provides an image including a plurality of label images. The scanner 12 supplies the scanned image (input image) including the plurality of label images arranged in an arbitrary direction to the system control unit 15 as illustrated in FIG. 10. The system control unit 15 cuts out the individual label images 91, 92, 93, 94, and 95 that were arranged in an arbitrary direction in the scanned image. The system control unit 15 recognizes the top and bottom of the individual label images 91, 92, 93, 94, and 95 and corrects inclination of the individual label images as necessary based on the top and bottom recognition result. Accordingly, in this example, the system control unit 15 acquires the five label images 91, 92, 93, 94, and 95 in the state illustrated in FIG. 11.

The system control unit 15 requests for the server 7 to generate label data for each of the individual label images acquired from the scanned image. For example, the system control unit 15 transmits the individual label images 91, 92, 93, 94, and 95 together with the request for generation of label data to the server 7.

In some examples, the system control unit 15 may 15 may execute processing for detecting a specific image area for the individual label images. For example, as a specific image area to be detected from the individual label images, the image area of the variable data or a display area of personal information is assumed. The variable data image area is an area that needs to be specified when creating the label data from the label image. The display area of the personal information is assumed to be a masked area (an area where the image contents are made unrecognizable, e.g., blurred) in the label image in order to protect the personal information contained in the original scanned image.

In addition, as a method for detecting a specific image area from the label image by the system control unit 15, there is a method for detecting the marked area.

For example, the operator arranges the label with the variable data area marked using a predetermined type of marker (e.g., a highlighter, a redacting marker, or the like) on the document platen 22. The digital multifunction peripheral 2 uses the scanner 12 to acquire the scanned image including the image of the label marked with a specific area. The system control unit 15 detects the marking images in the individual label images extracted from the scanned image. The system control unit 15 transmits the information indicating the area (variable data area) clearly indicated by marking together with the individual label images to the server 7.

Accordingly, the digital multifunction peripheral 2 can provide the information indicating the marked area in the label image to the server 7. As a result, the server 7 can clearly recognize the marked area in the label image. If the marked area is a variable data area, the server 7 can easily identify the variable data area in the label image.

In addition, the operator may arrange, on the document platen 22, a label marking/masking for the display area of the protected information such as personal information not to be transmitted to the server 7. The digital multifunction peripheral 2 detects a marking image in the individual label images cut out from the scanned image acquired by the scanner 12. In the case of operation for marking protected information, the system control unit 15 may transmit the label image which is the marked area is masked (converted display contents to an unrecognizable state) to the server 7. Accordingly, the digital multifunction peripheral 2 can transfer a label image in a state in which the display area of the information to be protected (such as personal information) has been masked to the server 7. As a result, the risk of leakage of information that should be protected, such as personal information in the label image, on a communication path between the digital multifunction peripheral 2 and the server 7 can be reduced.

In addition, as a method for detecting a specific image area, there is also a method for detecting a display area of information according to a specific character string from the positional relationship with respect to the display position of the specific character string. For example, the system control unit 15 executes character recognition on the label image. The system control unit 15 detects a specific character string from the result of character recognition on the label image. The system control unit 15 then detects an image area (for example, an image area adjacent to the character strings “name”, “address”, and “telephone number”) at a position corresponding to the detected specific character string.

Accordingly, the digital multifunction peripheral 2 can detect the display areas of information to be protected, such as personal information, by character recognition. In this case, the digital multifunction peripheral 2 can transfer the label image while masking the display area of information to be protected, such as personal information, to the server 7. As a result, the risk of leakage of information that should be protected, such as personal information in the label image, on the communication path between the digital multifunction peripheral 2 and the server 7 can be reduced.

Next, an example of label image analysis and label data generation processing in the server 7 of the label printing system 1 according to an embodiment will be described.

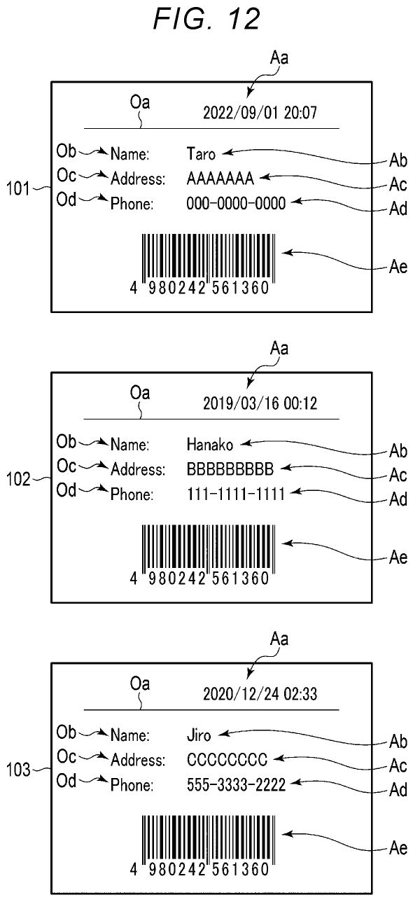

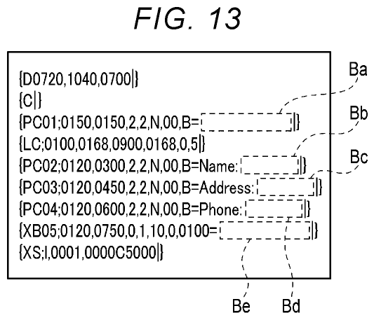

FIG. 12 is a diagram illustrating an example of the plurality of label images acquired by the server 7 from the digital multifunction peripheral 2. FIG. 13 is a diagram illustrating an example of label data generated based on the plurality of label images illustrated in FIG. 12.

For example, a user arranges the plurality of the same type of printed labels on the document platen 22 and instructs scanning execution. After the scanning execution is instructed, the digital multifunction peripheral 2 uses the scanner 12 to read an image including the three labels on the document platen 22. The system control unit 15 acquires the scanned image from the scanner 12 and cuts out the three individual label images included in the scanned image. The system control unit 15 performs image processing, such as inclination adjustment, on the individual label images. Accordingly, the system control unit 15 acquires the three label images 101, 102, and 103 as illustrated in FIG. 12. The system control unit 15 transmits the acquired three label images 101, 102, and 103 to the server 7 together with the request for generation of the label data.

The server 7 receives the request for generation of the label data and the three label images 101, 102, and 103 from the digital multifunction peripheral 2. The server 7 generates the label data as illustrated in FIG. 13 by analyzing the acquired three label images.

The server 7 extracts elements constituting area labels from the three label images 101, 102, and 103, respectively. The server 7 in this example extracts the positions and presence of image areas Aa, Ab, Ac, Ad, and Ae, the partition line Oa, as well as the, positions, presences, and content of the texts Ob, Oc, and Od from the three label images 101, 102, and 103. In particular, the server 7 identifies the coordinates for the image areas Aa, Ab, Ac, Ad, and Ae, the partition line Oa, the texts Ob, Oc, and Od that coincide with each other in the three label images. The server 7 may at this time determine that the three label images are the same type labels since positions of the plurality of elements coincide with each other.

The server 7 identifies an image area for variable data by comparing image contents of respective elements for which coordinates coincide with each other. According to the example illustrated in FIG. 12, the specific content in the image areas Aa, Ab, Ac, and Ad of the three label images 101, 102, and 103 are different. Accordingly, the server 7 specifies that the image areas Aa, Ab, Ac, and Ad are areas for variable data.

For example, the server 7 recognizes by character recognition on the image area Aa that the variable data printed on the image area Aa is data of a date provided as a numeric string. In addition, the server 7 recognizes by the character recognition for the text Ob and/or the image area Ab that the variable data printed on the image area Ab is a “name”. In addition, the server 7 recognizes by the character recognition for the text Oc and/or the image area Ac that the variable data printed on the image area Ac is an “address”. In addition, the server 7 recognizes by the character recognition for the text Od and/or the image area Ad that the variable data printed on the image area Ad is a “telephone number”. In addition, the server 7 recognizes through image recognition on the image area Ae that the variable data printed on the image area Ae is a bar code.

The server 7 generates a format of label data based on analysis results of the three label images 101, 102, and 103 as described above. For example, the server 7 generates the label data for defining the position and the like of each element extracted from the three label images 101, 102, and 103. In addition, as illustrated in FIG. 13, the server 7 defines the data areas Ba, Bb, Bc, and Bd for storing the variable data to be printed on the image areas Aa, Ab, Ac, and Ad in the label data. Furthermore, the server 7 may add information to the label data for defining the input device for providing the variable data to be stored in the image areas Aa, Ab, Ac, and Ad.

Next, the overall operations of the label printing system 1 according to an embodiment will be described.

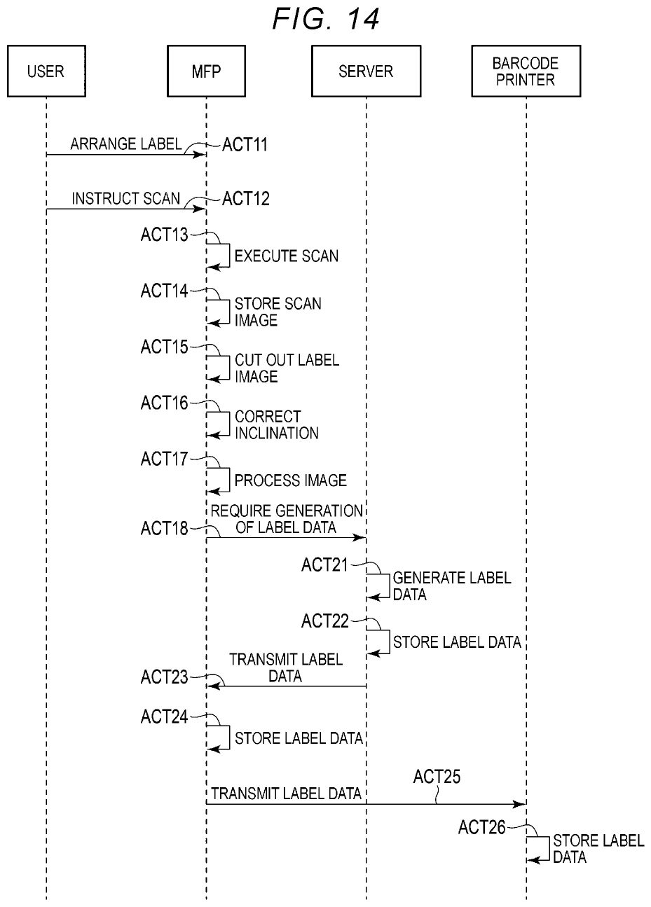

FIG. 14 is a sequence diagram for describing an operation example of a label printing system 1 according to an embodiment.

First, a user arranges a printed label on the document platen 22 of the digital multifunction peripheral 2 (ACT 11). The user inputs an instruction to execute a scan using the operation button 43 or the touch panel 42 of the operation panel 14 after arranging the printed label (ACT 12).

The processor 50 of the system control unit 15 of the digital multifunction peripheral 2 acquires the instruction for scanning execution from the operation panel 14. The processor 50 executes scan processing by the scanner 12 after the instruction of scan execution is input (ACT 13). The scanner 12 scans the label on the document platen 22 in response to an instruction from the processor 50, and supplies the scanned image of the label to the system control unit 15. The processor 50 acquires the scanned image from the scanner 12 through the I/F 57. The processor 50 stores the scanned image (input image) in the image memory 52 or the storage device 54 (ACT 14).

The processor 50 of the system control unit 15 individually extracts the images of the labels included in the scanned image after the scanned image is stored (ACT 15). The processor 50 determines the top and bottom of the individual extracted label image(s), and corrects the inclination of the individual label image(s) as necessary (ACT 16). Furthermore, the processor 50 executes predetermined image processing on the individual label image(s) after inclination is corrected (ACT 17).

For example, the processor 50 performs processing for detecting the areas marked in a label image as a variable data area. In this case, the processor 50 detects a marking image from the individual label images and detects an area (marked area) indicated by the marking image as a variable data area. In this case, the processor 50 adds information indicating a marked area as a variable data area and additional information to the label image.

In other examples, the processor 50 may detect protected information, such as personal information, from the label images and mask the display area of the protected information. For example, the processor 50 detects the protected information and the display area of the protected information by character recognition results on the label image. In some examples, the processor 50 may detect a marked image in the individual label images and may detect the area corresponding to the marked image as the display area of protected information.

If the processor 50 detects a display area of protected information in the label image, the processor 50 can execute processing (mask processing) to mask the protected information so as not to be recognizable in the post-processed image. The mask processing may be a process that makes the protected information unrecognizable. For example, as the mask processing, the display area of the protected information may be painted out in black or darkly shaded. In addition, as the mask processing, the protected information may be abstracted, blurred, or converted into predetermined dummy information or the like.

The processor 50 of the digital multifunction peripheral 2 sends a request for the generation of the label data to the server 7 after the appropriate image processing is performed on the individual label images (ACT 18). The processor 50 communicates with the server 7 through the communication interface 55. Once communication with the server 7 is established, the processor 50 transmits a request to generate the label data along with the individual label images after image processing to the server 7.

The server 7 acquires the generation request and the individual label images by the communication interface 74. The processor 71 of the server 7 stores the received individual label image(s) in the storage unit 73. After the processor 71 stores the individual label image(s) in the storage unit 73, the processor 71 generates the label data by analyzing the individual label image(s) (ACT 21).

For example, as described above, the processor 71 extracts each label element from the individual label image(s) and compares the elements with elements of other label images to generate the label data. In addition, the processor 71 may generate the label data by comparing the just provided label image data with a label image received in the past and stored in storage unit 73. It is noted that the method for generating the label data is not limited to the above examples, and any method may be used as long as label data can be generated from the individual label images.

After the processor 71 of the server 7 generates the label data from the label image(s), the processor 71 of the server 7 stores the generated label data in the storage unit 73 (ACT 22). In addition, the processor 71 of the server 7 transmits the generated label data to the digital multifunction peripheral 2 (ACT 23).

The digital multifunction peripheral 2 acquires the label data from the server 7 through the communication interface 55. After transmitting the generation request to the server 7, the processor 50 waits to receive the label data from the server 7. Once the processor 50 receives the label data requested from the server 7, the processor 50 stores the label data in the storage device 54 (ACT 24).

After processor 50 acquires the label data from the server 7, the processor 50 may transmit the acquired label data to the bar code printer 6 via the external I/F 56 (ACT 25). In this process, the processor 50 may confirm that the label data acquired from the server 7 is for a label that can be printed by the particular bar code printer 6. For example, the processor 50 checks whether the width size of the label to be printed based on the label data matches the width size of a printable label for the bar code printer 6. In this case, the processor 50 may not transmit the label data if the width size is not a printable size for the bar code printer 6.

The bar code printer 6 acquires the label data from the digital multifunction peripheral 2 by the external interface 64. After the processor 61 of the bar code printer 6 receives the label data from the digital multifunction peripheral 2, the processor 61 stores the received label data in the storage unit 63 (ACT 26). Accordingly, the bar code printer 6 can read the label data stored in the storage unit 63 according to the instruction of an operator and print the label.

As described above, the label printing system 1 has a digital multifunction peripheral 2 including an image processing apparatus, a server 7, and a bar code printer 6. The digital multifunction peripheral 2 cuts out a printed label image from an input image such as a scanned image, and requests the server 7 to generate label data for individual label images. The server 7 generates the label data by analyzing a label image from the digital multifunction peripheral 2 and transmits the generated label data to the digital multifunction peripheral 2. The digital multifunction peripheral 2 supplies the label data generated by the server 7 to the bar code printer 6.

Accordingly, the label printing system 1 according to an embodiment can acquire the label data from a previously printed label without operating an label editing tool on the PC. As a result, the label printing system can save labor in the generation of the label data and can easily acquire the label data.

Next, the operation of the digital multifunction peripheral 2 including an image processing apparatus according to an embodiment will be described.

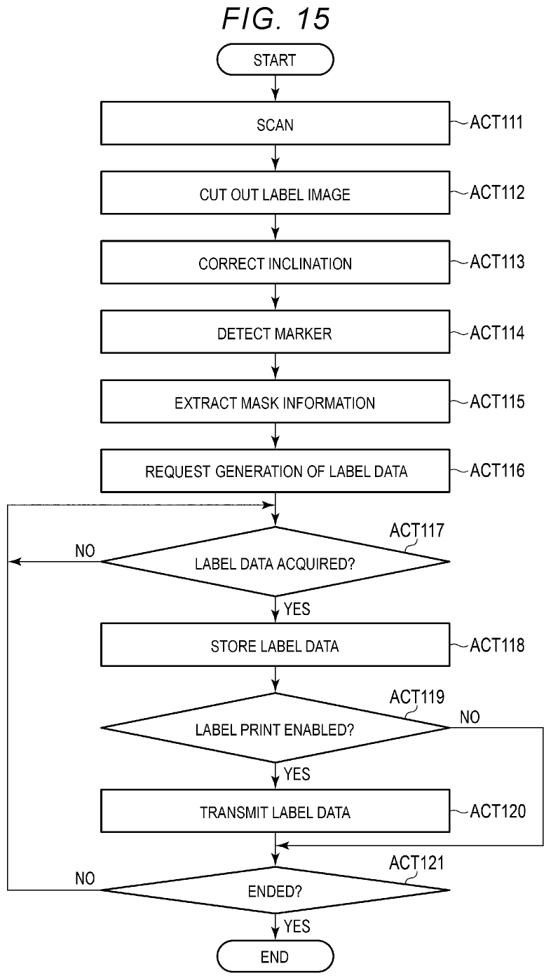

FIG. 15 is a flowchart illustrating the operation example of a digital multifunction peripheral 2 according to an embodiment.

The system control unit 15 of the digital multifunction peripheral 2 receives an instruction for the scanning execution from the operation panel 14. The processor 50 of the system control unit 15 executes scanning with the scanner 12 (ACT 111). In other examples, the system control unit 15 may 15 may acquire a label image from another image reader type or a camera instead of the scanner 12.

The processor 50 acquires the scanned image from the scanner 12 through the I/F 57. The processor 50 stores the scanned image in the image memory 52.

The processor 50 executes processing for cutting out (extracting) individual label images from the scanned image (ACT 112). The processor 50 then corrects inclination to the individual label images (ACT 113).

In this example, the processor 50 then detects a marking image (a marker) in the individual label images (ACT 114). If a marker is detected in a label image, the processor 50 identifies the marking area indicated by the detected marker. The processor 50 adds the information indicating the specified marking area as additional information to the label image. When no marker is detected, or when not detecting a marker, the processor 50 skips processing of ACT 114.

The processor 50 detects protected information (masked information) such as personal information in the label image (ACT 115). When detecting the masked information, the processor 50 executes the mask processing for masking the display area of the masked information in the label image. When masked information is not detected or when not detecting masked information, the processor 50 skips processing of ACT 115.

After the processor 50 performs image processing on the individual label images, the processor 50 transmits a label data generation request together with individual label images to the server 7 (ACT 116). After transmitting the request to the server 7, the processor 50 receives the label data from the server 7. In other words, the processor 50 waits to receive the label data from the server 7 (ACT 117, NO).

After the processor 50 receives the label data from the server 7 (ACT 117, YES), the processor 50 stores the label data acquired from the server 7 in the storage device 54 (ACT 118).

After the processor 50 acquires the label data from the server 7, the processor 50 may determine whether the printing capability (such as printable size) of the bar code printer 6 to which the label data is to be transmitted matches the label data parameters. For example, the processor 50 reads the printing capability information of the bar code printer 6 as stored in the storage device 54. In some examples, the processor 50 may send request printing capability information from the bar code printer 6 before transmitting the label data.

After the processor 50 determines the printing capability of the bar code printer 6, the processor 50 then determines whether or not the label can be printed by the bar code printer 6 according to the label data acquired from the server 7 (ACT 119). If the bar code printer 6 cannot print a label according to the label data (ACT 119, NO), the processor 50 omits transmission of the label data and proceeds to ACT 121. If the bar code printer 6 can print the label according to the label data (ACT 119, YES), the processor 50 transmits the label data to the bar code printer 6 (ACT 120).

After the processor 50 transmits the label data to the bar code printer 6, the processor 50 determines whether or not acquisition processing of the requested label data is completed (ACT 121). If the acquisition processing of the label data is not completed (ACT 121, NO), the processor 50 returns to ACT 117 and executes processing for the next label data. If the acquisition processing of the label data is completed (ACT 121, YES), processing is ended.

As described above, the digital multifunction peripheral 2 according to an embodiment communicates with a bar code printer 6 and a server 7. The digital multifunction peripheral 2 provides a scanned image including the printed label image(s) and cuts out the individual label images from the scanned image. The digital multifunction peripheral 2 performs image processing including inclination correction on the individual label images from the scanned image. The digital multifunction peripheral 2 transmits the request for generation of label data and the individual label image(s) to the server 7. The digital multifunction peripheral 2 supplies the label data acquired from the server 7 to the barcode printer 6. Accordingly, the digital multifunction peripheral 2 can provide label data generated from an image of a printed label to the bar code printer 6 without the need for a label editing tool. As a result, according to the label printing system 1, labor can be saved in creating label data.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus, comprising:
a first interface for communicating with a server;
a second interface for communicating with a label printer;
a third interface for acquiring an image including a label image; and
a processor configured to:
receive the image via the third interface;
extract the label image from the received image;
perform image processing on the extracted label image;
transmit the processed extracted label image to the server via the first interface along with a request to generate label data based on processed extracted label image;
receive the generated label data from the server via the first interface; and
transmit the received label data to the label printer along with a request to print a label corresponding to the label data.

2. The image processing apparatus according to claim 1, wherein the image processing includes detecting a marking image in the extracted label image and obscuring information associated with the marking image in the extracted label image.

3. The image processing apparatus according to claim 1, wherein the image processing includes identifying a display area of protected information in the extracted label image and masking the display area of the protected information.

4. The image processing apparatus according to claim 1, wherein the processor is further configured to determine whether the label printer is capable of printing the label corresponding to the received label data.

5. The image processing apparatus according to claim 1, wherein the image processing includes inclination correction of the extracted label image.

6. The image processing apparatus according to claim 1, wherein the image processing includes performing optical character recognition on the extracted label image to detect protected information.

7. The image processing apparatus according to claim 1, further comprising:
a printing unit for forming images on a sheet.

8. The image processing apparatus according to claim 1, further comprising:
a scanner connected to the third interface, wherein
the image including the label image is a scanned image from the scanner.

9. A multifunctional peripheral device, comprising:
a printing unit for forming images on a sheet;
a scanner for scanning documents;
a first interface for communicating with a server;
a second interface for communicating with an external label printer;
a third interface for acquiring an image including a label image; and
a processor configured to:
receive the image via the third interface;
extract the label image from the received image;
perform image processing on the extracted label image;
transmit the processed extracted label image to the server via the first interface along with a request to generate label data based on processed extracted label image;
receive the generated label data from the server via the first interface; and
transmit the received label data to the external label printer along with a request to print a label corresponding to the label data.

10. The multifunctional peripheral device according to claim 9, wherein the image processing includes detecting a marking image in the extracted label image and obscuring information associated with the marking image in the extracted label image.

11. The multifunctional peripheral device according to claim 9, wherein the image processing includes identifying a display area of protected information in the extracted label image and masking the display area of the protected information.

12. The multifunctional peripheral device according to claim 9, wherein the processor is further configured to determine whether the label printer is capable of printing the label corresponding to the received label data.

13. The multifunctional peripheral device according to claim 9, wherein the image processing includes inclination correction of the extracted label image.

14. The multifunctional peripheral device according to claim 9, wherein the image processing includes performing optical character recognition on the extracted label image to detect protected information.

15. The multifunctional peripheral device according to claim 9, wherein the image including the label image includes a plurality of label images.

16. The multifunctional peripheral device according to claim 9, wherein the image including the label image is a scanned image from the scanner.

17. A label printing system, comprising:
a server device configured to generate label data from label images; and
a multifunctional peripheral device including:
a first interface for communicating with the server;
a second interface for communicating with a label printer;
a third interface for acquiring an image including a label image; and
a processor configured to:
receive the image via the third interface;
extract the label image from the received image;
perform image processing on the extracted label image;
transmit the processed extracted label image to the server device via the first interface along with a request to generate label data based on processed extracted label image;
receive the generated label data from the server via the first interface; and
transmit the received label data to the label printer along with a request to print a label corresponding to the label data.

18. The label printing system according to claim 17, further comprising:
the label printer.

19. The image printing system according to claim 17, wherein the multifunctional peripheral device further includes:
a printing unit for forming images on a sheet.

20. The image printing system according to claim 17, wherein the multifunctional peripheral device further includes:
a scanner connected to the third interface, wherein
the image including the label image is a scanned image from the scanner.
